(19) United States
(12) Patent Application Publication
(10) Pub. No.: US 2009/0009100 A1
(43) Pub. Date: Jan. 8, 2009

(54) Reactive Circuit and Rectifier Circuit

(76) Inventor: Johannus Otto Rooymans, Ermelo (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(21) Appl. No.: 11/794,778

(22) PCT Filed: Jan. 5, 2006
(86) PCT No.: PCT/NL2006/050003

§ 371 Date: Jul. 5, 2007

(30) Foreign Application Priority Data
Jan. 5, 2005 (NL) 1027960
Aug. 5, 2005 (NL) 1029688

(51) Int. Cl. H05B 41/24; H05B 41/16

(52) U.S. Cl. 315/246

(57) ABSTRACT

The invention relates to a reactive circuit for correction of a power factor in an electrical network. The reactive circuit has at least one supply connection for supplying an alternating power supply (1) current and an input stage that is connected to the at least one supply connection. The reactive circuit is furthermore provided with one or more LEDs (12, 13). In use, the reactive circuit has an essentially reactive input impedance and the input stage generates a correction current. The reactive circuit is set up for lighting a space by loading the one or more LEDs with the at least nearly full correction current.

The invention relates to a reactive circuit for collection of a power factor in an electrical network comprising
at least one supply connection for supplying an alternating power supply current;
an input stage that is connected to the at least one supply connection and in use generates an essentially reactive input impedance and a correction current;
one or more LEDs.

A reactive circuit for correction of a power factor in an electrical network is disclosed in Dutch Patent 1022784. This document describes a reactive circuit for charging a battery. The reactive circuit furthermore includes a rectifier circuit for rectifying the alternating power supply current supplied and an output stage with connection means for supplying the rectified current to poles of the battery to be charged. The power that is stored in the battery can be used for a wide range of things. The correction of the power factor in the electrical network is not constant and of limited duration. Another load is desirable in order to be able to apply a more permanent correction. In an embodiment the circuit also contains light-producing elements, that is to say two Light Emitting Diodes (LEDs) connected in parallel. These are indicative in nature, that is to say they are warning lamps, and because of a lack of power are unsuitable for lighting a space on their own.

The present invention is based on the insight that a more permanent correction of the power factor in an electrical network can be achieved while a space can be lit by providing a lighting device with a reactive circuit characterised in that the reactive circuit is set up for lighting a space by loading one or more LEDs with the at least nearly full correction current. The power factor in an electrical network can be improved with such a circuit, while the one or more LEDs can be used as stand-alone light source.

U.S. Pat. No. 5,726,535 describes a lamp provided with series of LEDs (LED strings), especially for use in flashing traffic signs, where the flashing frequency is the same as the frequency of the alternating voltage applied. The lamp can be rotated at its base, with a maximum angle of rotation of 160°, in order to maximise the light intensity in the direction of the area to be lit. The resistance of the LED strings is high, as a result of which the correction current is negligible and the LEDs cannot be loaded with a nearly full correction current la addition, the reverse loading of each individual LED is indeterminate.

Preferably the correction current has an electrical current intensity of at least 200 mA. Such a current intensity is particularly suitable for making LEDs function with sufficient light output. Examples of such LEDs are so-called power LEDs.

Furthermore, the lighting device preferably includes at least one capacitor connected in series between the at least one supply connection and the at least one rectifier element. The at least one capacitor functions as current source and ensures that the current that flows through the one or more LEDs is nearly constant.

The circuit can be placed on a substrate, wherein a first heat-conducting surface has been applied to a first side of the substrate and an electrically conducting surface has been applied to a second side of the substrate, which electrically conducting surface is organised for permanent joining to the one or more LEDs. In order to increase reliability of the circuit and, at the same time, to be able to keep complicated connection techniques to a minimum, the permanent joining of the one or more LEDs to the electrically conducting surface on the second side of the substrate is preferably achieved by soldering, for example with a solder that comprises gold (Au) and tin (Sn). For good heat conduction, on the one hand, and good resistance to deformation with regard to temperature differences, on the other hand, the electrically conducting surface preferably comprises at least one of the elements from the group comprising silver, chromium, nickel and copper.

The reactive circuit preferably comprises a two-phase rectifier circuit that loads one or more LEDs for each phase. The advantage of such a circuit is that for both phases the components that are vulnerably loaded for one phase are relieved by the components that are set up for the other phase. All components of such a rectifier circuit are thus protected. More particularly, the two-phase rectifier circuit is a diode bridge circuit, wherein the diode bridge circuit comprises a current branch comprising diodes for each phase, wherein part of both current branches comprises a common section and the common section comprises the one or more LEDs. In this way a higher light output can be obtained in an effective manner, because the light-producing element now generates light for both phases. In an embodiment hereof the common section of both current branches comprises at least two parallel electrically conducting paths that each contain at least one or more LEDs. In this way the current through the common section can be distributed over the at least two parallel electrically conducting paths, as a result of which the load on each individual LED is reduced.

Preferably, at least one additional capacitor is connected in parallel with the common section of both current branches. This capacitor serves as buffer for harmonic distortions in the electrical network.

It is possible mat one or more diodes from the diode bridge circuit are LEDs. In that case the light output of the circuit can be increased in a simple manner without increasing the number of components.

With more light-producing elements it is possible that the colour of the light that each LED generates in use is different for different LEDs. As a result of this different light, colours can be generated. It is possible to generate white light with a suitable combination of LEDs with a suitable distribution of wavelengths.

In another embodiment of the invention, the reactive circuit comprises a bridge circuit containing several diode bridge circuits, wherein each diode bridge circuit comprises a current branch containing diodes for each phase, wherein part of both current branches comprises a common section and the common section comprises one or more LEDs. By incorporating several diode bridge circuits in a bridge circuit, the time until breakdown, also called mean time to failure (MTTF), of the reactive circuit is extended. It is possible in this case as well to have the reactive circuit generate different light colours. This can, for example, be achieved by having bridge circuits generate light with different wavelengths. It is possible to generate white light with a suitable combination of bridge circuits with a suitable colour.

In an embodiment thereof, the reactive circuit furthermore includes an adjusting element for setting the colour to be emitted. The adjusting element can be a variable resistor. In an embodiment, the adjusting element is incorporated in a colour correction circuit. Such a colour correction circuit ensures that variation, resulting from heat generation in the LED, in a spectrum of wavelengths that is emitted by the one or more LEDs is kept to a minimum and is compensated where necessary.

In an embodiment, such a colour correction circuit comprises a transistor and a negative temperature coefficient (NTC) resistor as adjusting element. Such a resistor is very suitable when a substrate made of ceramic is used. In another embodiment, such a colour correction circuit comprises a transistor and a phototransistor, such as, for example, a Darlington transistor chip that is preferably positioned close to one of the one or more LEDs, as adjusting element.

In all embodiments, the input stage can be made up of a capacitor array, constituted by one or more capacitors connected in parallel. Such a capacitor array makes it possible to use the reactive circuit at various currents. It must be understood that the concept input stage can mean both input stage and output stage. After all, by applying an alternating current during use the input stage will serve as output stage for half of the time.

Furthermore, the supply connection of the reactive circuit is preferably suitable for connection to an electricity network. Such a network is available virtually everywhere and makes the device easy to use.

The reactive circuit preferably furthermore comprises a protection circuit. Such a protection circuit serves to protect against incidental electrical loads, such as current/voltage peaks, on elements in the reactive circuit.

The invention further relates to a rectifier circuit for electrically loading at least one LED, wherein the rectifier circuit is a two-phase rectifier circuit that comprises a diode bridge circuit, wherein the diode bridge circuit comprises a current branch comprising diodes for each phase, characterised in that part of both current branches comprises a common section, wherein the common section comprises the at least one LED and the at least one LED is loaded to an electrical power of at least 60 mW.

In an embodiment hereof the common section of both current branches comprises at least two parallel electrically conducting paths that each comprise at least one or more LEDs. In this way the current through the common section can be distributed over the at least two parallel electrically conducting paths, as a result of which the load on each individual LED is reduced.

Preferably, at least one capacitor is connected in parallel with the common section of both current branches. This capacitor serves as buffer.

It is possible that one or more diodes from the diode bridge circuit are LEDs. In that case the light output of the rectifier circuit can be increased in a simple manner without increasing the number of components.

With more light-producing elements it is possible that the colour of the light that each LED generates in use is different for different LEDs. As a result of tins different light, colours can be generated. It is possible to generate white light with a suitable combination of LEDs with a suitable distribution of wavelengths.

The invention will be explained in more detail below by way of example with reference to the following figures. The figures are not intended to restrict the scope of the invention, but solely to be an illustration thereof.

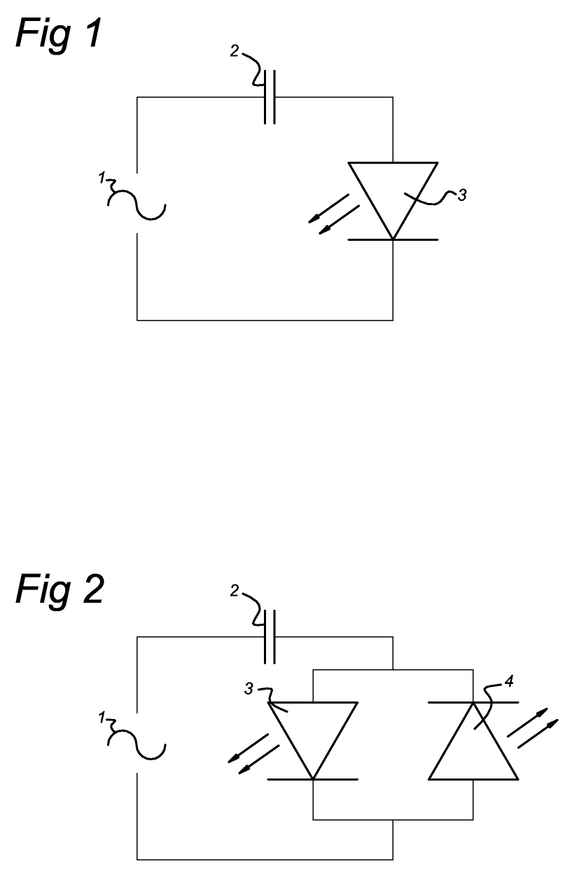

FIG. 1 schematically shows a circuit according to a first embodiment of the present invention;

FIG. 2 schematically shows a circuit according to a second embodiment of the present invention;

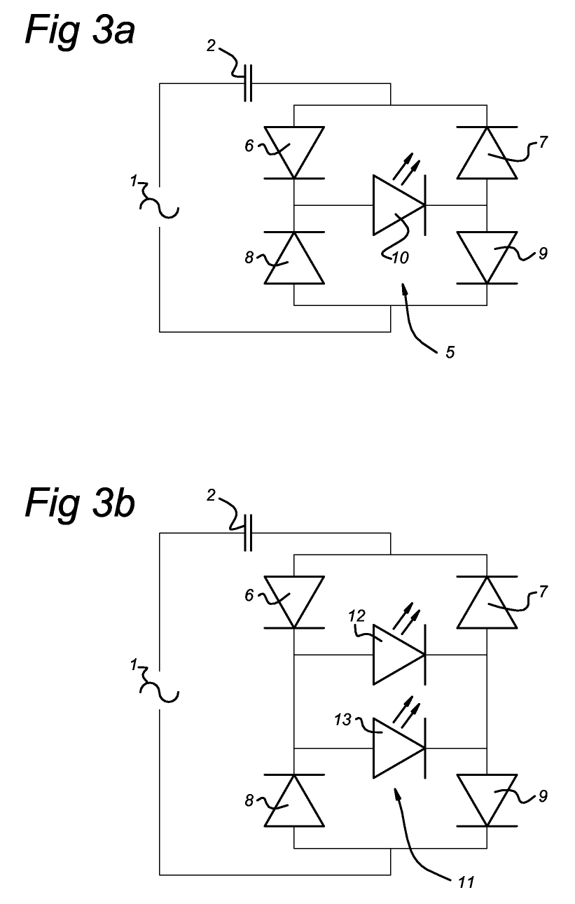

FIGS. 3a, 3b schematically show a circuit according to a third and a fourth embodiment of the present invention, respectively;

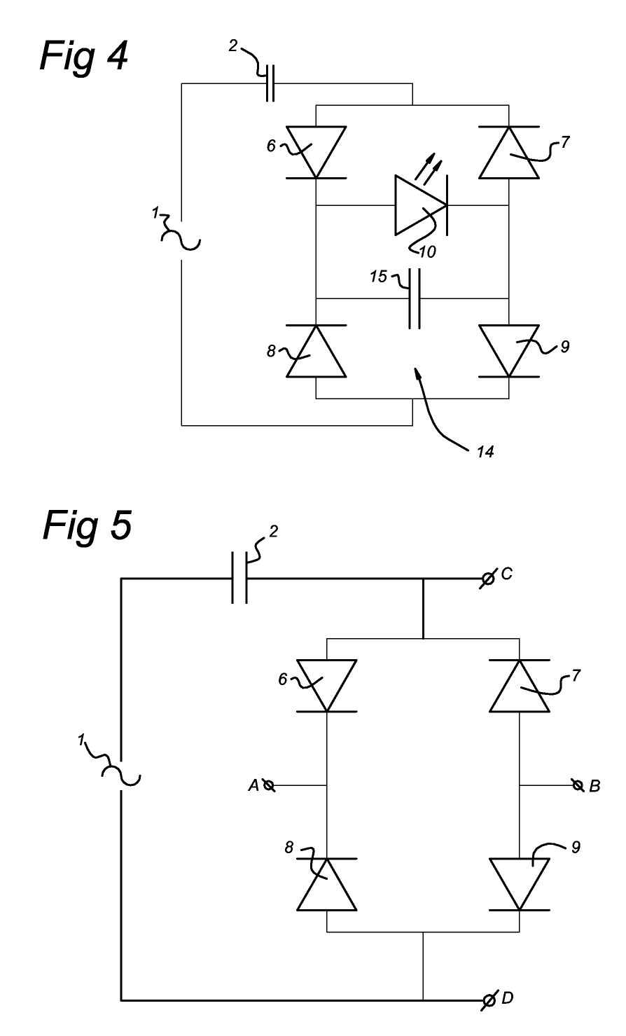

FIG. 4 schematically shows a circuit according to a fifth, embodiment of the present invention;

FIG. 5 schematically shows a corresponding part of the circuits as shown in FIGS. 3a, 3b and 4;

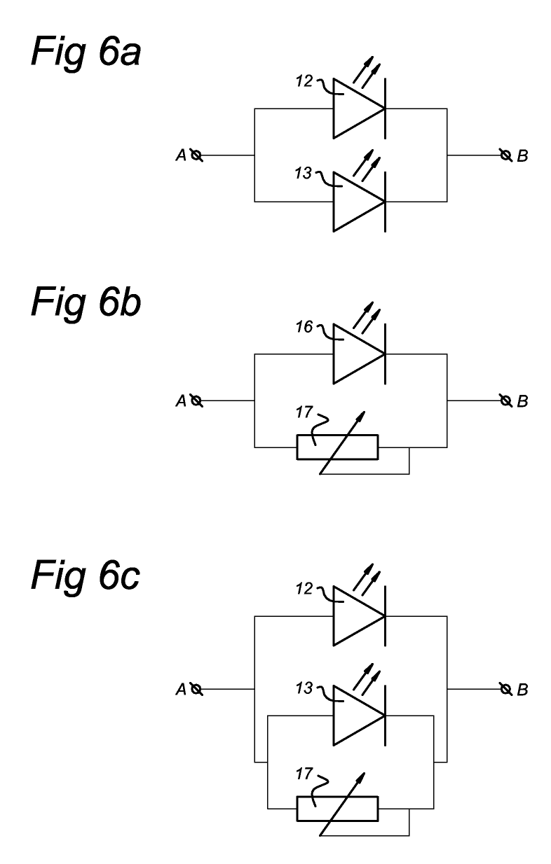

FIGS. 6a-c schematically show various circuits that can be used in a direct current branch of the circuit shown in FIG. 5;

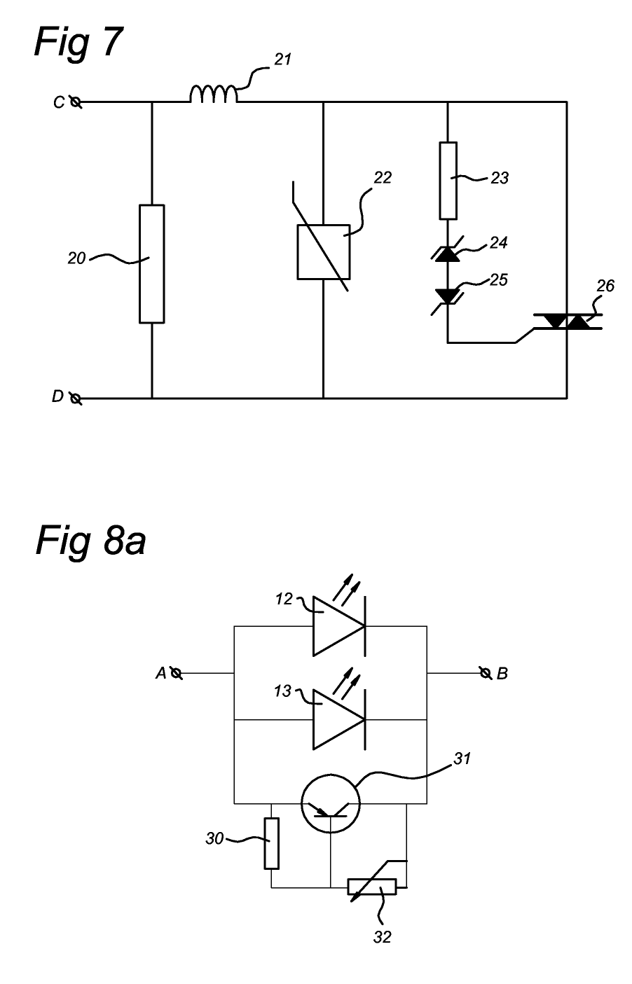

FIG. 7 schematically shows an embodiment of a protection circuit;

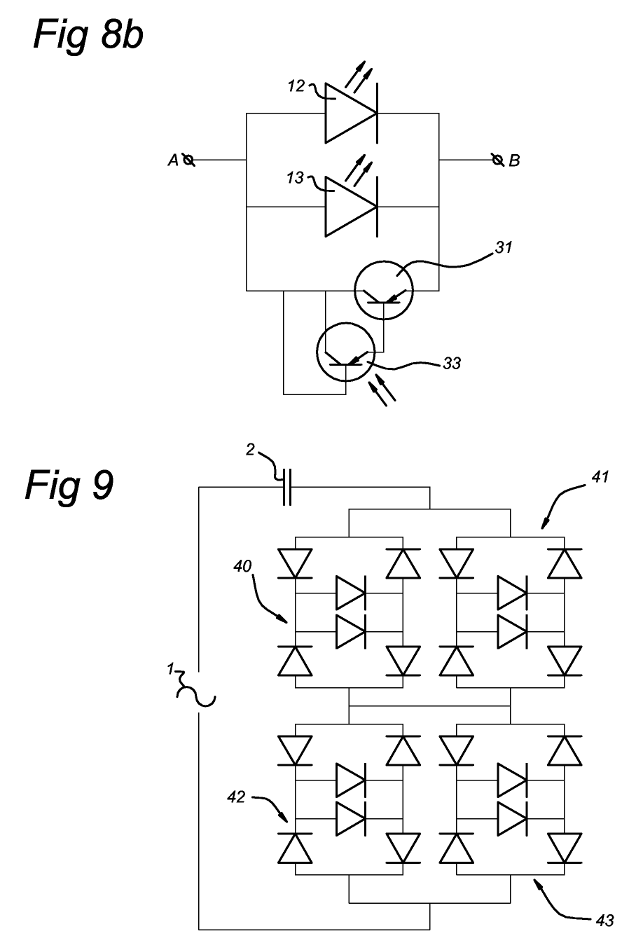

FIGS. 8a, 8b schematically show two possible colour correction circuits;

FIG. 9 schematically shows a circuit according to a sixth embodiment of the present invention;

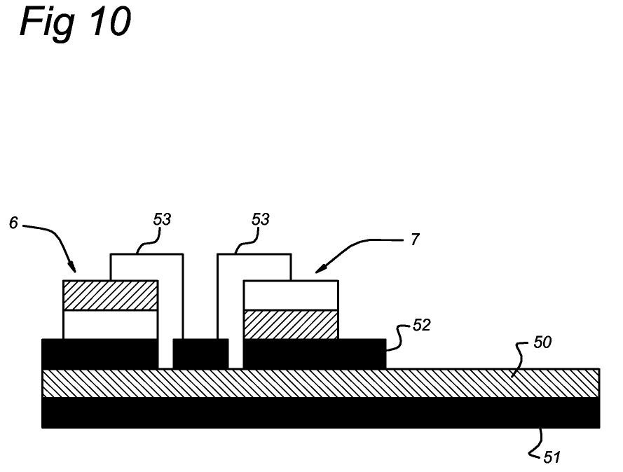

FIG. 10 schematically shows a side view of a circuit according to an embodiment of the present invention.

Electric power can be divided into two parts; one part comprises work on a resistive load. This is called effective work and this is expressed in Watt. The other part comprises work that is carried out on a reactive load. This is called ineffective work, which is expressed in VAR. The ratio between both types of work is also called the power factor or cos φ. In practice, it is found that the aggregate of electrical equipment that is connected to the electricity network results in the electricity network being inductively loaded. As a result of this inductive load the power factor of the electricity network is less than 1. The higher the inductive load, the lower this power factor will be.

A low power factor for the electricity network will result in an increase in the current on a load that is necessary to be able to perform a desired effective work on a load. As a result of this, higher losses will occur during the distribution of the electric power. Furthermore, the inductive load generates undesirable noise in the electrical network by harmonic distortions in current and voltage.

A known manner for correcting, or at least improving, the power factor and, at the same time, avoiding harmonic distortions as far as possible, is to install capacitors (capacities) in parallel with the network. Preferably, this is done as close as possible to the location where the inductive load is generated. The correction is achieved as a result of the fact that the direction of a capacitative current is opposed to an inductive current. Consequently the inductive current will decrease on summation of both currents, in other words the capacitative current functions as a correction current. However, this method of current correction with a capacitor is not optimum, because the capacitative current is fixed, whilst the inductive current is dependent on the mechanical, and with this the inductive, load. The lower the reactance of the capacitors, the higher the correction current. However, too high a correction current can damage the capacitor. In order to prevent this, the capacitor can be connected to an element with a low resistance. The present invention is based on the insight that a light source, such as one or more diodes, can be used for such a resistance, so that the power consumed therein can be used efficiently.

FIG. 1 schematically shows a reactive circuit according to a first embodiment of the present invention. In the figure, an alternating current network 1 is connected to a capacitor 2. A light-producing rectifier, for example a Light Emitting Diode (LED) 3, is connected in series with the capacitor 2. The particular feature of this circuit is that the diode 3 not only protects the capacitor 2, but is also the loaded element. The circuit shown generates light without exerting an inductive load on the alternating current network 1. Instead of one diode 3, obviously several diodes in series can also be set up, optionally all light producing, as long as the total resistance is not too large. In order to obtain sufficient light output, it has been found that the one or more light-producing diodes 3 consume at least a power of 60 mW.

Capacitor 2 must be capable of withstanding surging of the voltage originating from the alternating current network 1. It is also important that the capacitor has (practically) no leakage resistance.

Suitable LEDs comprise so-called ultra-bright light emitting diodes (UB-LEDs) and so-called power LEDs. The typical current intensity through a UB-LED is 20 mA. Power LEDs currently typically work at current intensities of 200-350 mA, but there are also already power LEDs that work up to a current intensity of 1 A. The light output of a typical UB-LED is about 2-3 lumen, whilst the light output of a typical power LED is between 15 and 40 lumen.

The reactance Rₓ of the capacitor 2 is determined by the formula Rₓ=V/I=½πfC. For a current of 20 mA, as is usual with the use of a UB-LED, at a network voltage of 230 V, the reactance is 11,500 ohm. If the electrical alternating current network 1 has a network frequency of 50 Hz, the capacitance consequently has a value of 0.27 μF. At a network voltage of 127 V and a network frequency of 60 Hz, the value of the capacitance C of the capacitor is 0.41 μF according to the same sort of calculation. In contrast, with the use of power LEDs the values of the capacitance of the capacitor 2 are higher. For current intensities of 200 mA to 350 mA, capacitances C of 2.7 μF to 4.1 μF can be used according to me preceding calculation.

The connection to the alternating current network 1 can be accomplished as is known in the state of the art, for example by means of pins in a plug which can be inserted in a socket connected to an electricity network. The light-producing rectifier can also be connected via a capacitor array (not shown) to die alternating current network 1 instead of to one capacitor 2, such as shown in FIG. 1. The capacitor array comprises one or more rows of capacitors connected in parallel that can be included in or excluded from the circuit with the aid of switches that can be operated independently of one another. What is achieved by the use of the capacitor 2 or the capacitor array is that an input stage of the reactive circuit renders a nearly full reactive input impedance when powered from the alternating current network 1, for example an electricity network with an alternating voltage that has a frequency range of between about 40 and 60 Hz. As a result of this, current intensity and voltage are virtually 90° out of phase. As a result of tins, the power factor of an otherwise inductively loaded electricity network is improved. In the case where a capacitor array is used, the switches make it possible to regulate the impedance of the input stage.

FIG. 2 schematically shows a circuit according to a second embodiment of the present invention. In contrast to the circuit in FIG. 1, the capacitor 2 is now connected in series with two light producing rectifiers set up in opposing directions, for example LEDs 3, 4 that are connected in parallel with respect to one another. The great advantage of this circuit is that in this circuit the capacity affords protection for both current directions (two-phase). At the same time the one rectifier that is loaded in its forward direction relieves the other rectifier that is in reverse direction at that moment.

FIGS. 3a, 3b schematically show a circuit according to a third and a fourth embodiment of the present invention, respectively. The low resistance in series with the capacitor 2 is now made up of a diode bridge circuit 5 and a diode bridge circuit 11, respectively. The diode bridge circuit 5 in FIG. 3a contains four diodes, 6, 7, 8, 9 that bring about two-phase rectification of the current through a fifth light-producing element, preferably a LED 10. In comparison to the circuits shown in FIGS. 1 and 2, the light that is emitted by LED 10 will exhibit a more constant intensity. After all, the LED 10 is under load in the forward direction for both current directions in the current circuit. Consequently, the frequency at which the LED is loaded will double. If the alternating power supply current has a frequency of 50 Hz, the LED 10 will experience a frequency of 100 Hz. More than one diode in series can also be put in the place of diodes 6, 7, 8, 9.

The diode bridge circuit 11 in FIG. 3b likewise contains four diodes 6, 7, 8, 9. Just as in FIG. 3a these bring about a two-phase rectification, however, now not through one LED 10, but through two tight-producing elements, preferably LEDs 12, 13, connected in parallel. Compared with the current through a LED 3, 4 in FIG. 2, LED 10 is under load twice as long at the same current. Because of the parallel connection of both LEDs 12, 13, each of them take a portion of the current for their account. As a result of the restriction of the amount of current per LED 12, 13, the anticipated life span of the circuit is extended.

The great advantage of a bridge circuit compared with a circuit in which light-producing elements, such as LEDs, are connected in series is that the reliability of the circuit is greater. A circuit such as shown in FIG. 3b will still remain on when one of the LEDs 12, 13 fails, whilst with a serial circuit failure of one or both LEDs 12, 13 will result in the circuit no longer functioning.

FIG. 4 schematically shows a circuit according to a fifth embodiment of the present invention. The circuit comprises a diode bridge circuit 14 that exhibits a great degree of similarity to the diode bridge circuit 5 in FIG. 3a. In contrast to diode bridge circuit 5, in diode bridge circuit 14 a capacitor 15 is connected in parallel with LED 10. Capacitor 15 serves as buffer and protects the LED 10 from damage when the circuit is connected to the supply. In addition, the capacitor 15 reduces the flickering of the LED 10. It must be understood that such a capacitor 15 can also be used in other circuits according to the present invention, for example placed in parallel with respect to LEDs 12, 13 in diode bridge circuit 11 in FIG. 3b. Furthermore, more man one capacitor can obviously also be connected in parallel in order to obtain the correct dimensioning of the circuit.

FIG. 5 shows a diode bridge circuit provided with diodes 6, 7, 8 and 9, wherein a connection A is indicated between diodes 6 and 8 and a connection B between diodes 7 and 9. A LED 10, as shown in FIG. 3a, two LEDs 12, 13 connected in parallel, as shown in FIG. 3b, and a LED 10 connected in parallel with capacitor 15, as shown in FIG. 4, can be connected between these connections A, B in order thus to form diode bridge circuits 5, 11, and 14, respectively, hi the diode bridge circuits shown, one or more of the diodes 6, 7, 8, 9 can also be LEDs. In an embodiment thereof, the direct current branch between A and B is linked with the aid of a short-circuit.

Furthermore, each LED can emit light of a certain specific wavelength. In other words, LEDs of any colour can be employed. In the case where several LEDs are used the colour of the light emitted can be influenced by choosing LEDs with suitable wavelengths. For instance, white tight can be generated with a correct combination of LEDs that emit red, green and blue light, respectively. FIGS. 6a-c show different circuit diagrams that can be connected in the direct current branch between the connections A and B which are suitable for generating different colours. FIG. 6a shows a circuit such as used in the circuit of FIG. 3b, wherein two LEDs 12, 13 are connected in parallel. If these LEDs 12, 13 do not emit the same colour light, the light emitted forms a mixed colour. In this way, for example, in the case where the four diodes 6, 7, 8, 9, as shown in FIG. 5, are LEDs that are set up for emitting light with a wavelength in a region around 590 nm, that is to say amber-coloured light, and the LEDs 12, 13 connected in parallel in FIG. 6a emit green light, that is to say light with a wavelength of about 525 nm and blue light, that is to say light with a wavelength of about 470 nm, then the circuit as a whole can, with a correct ratio with regard to the intensity of all LEDs 6, 7, 8, 9, 12, 13 in the circuit, emit white light.

An additional influence on the light that is emitted can be achieved by placing a variable resistor 17 in parallel with one or more LEDs 12, 13, 16, such as shown in FIGS. 6b and 6c. By varying the value of the resistance 17 the colour of the light emitted from the circuit as a whole can be influenced. The variable resistor 17 can be, for example, a potentiometer. In the light of the power that can be generated in the variable resistor 17, it is also possible to use a power transistor, where the base is regulated via a potentiometer at a lower current.

The circuit diagram that is shown in FIG. 6b can be used, inter aim, in an application in lamps for lighting at night as mentioned in Dutch Patent Application NL 1029231. For this application the four LEDs 6, 7, 8, 9 of the diode bridge circuit such as shown in FIG. 6b, are set up to emit light with a wavelength between 570 and 630 nm, that is to say amber/red light which is experienced as warm light. In order to obtain white light preferably light with a wavelength between 470 and 555 nm, that is to say green/blue-coloured light, is “mixed” with this. This could be done by making use of a circuit diagram as shown in FIG. 6a. However, the degree of addition of green/blue-coloured light is not always necessary. Consequently, good use of a circuit with a variable resistor as shown in FIG. 6b could be made in order to regulate the degree to which green/blue-coloured light is mixed with the amber light, depending on the location of the lamp and the local conditions.

FIG. 7 schematically shows an example of a protection circuit that can be connected to connections C and D as indicated in FIG. 5 for the protection of a diode bridge circuit 5, 11, 14. The LEDs in the diode bridge circuit are protected by this from excessive electrical loads such as peak voltages and the like. In the protection circuit shown, use is made of an additional resistor 20, a coil 21, a voltage-dependent resistor 22, also called varistor, and a resistor 23 in series with two opposed Zener diodes 24, 25 that are connected in parallel with a triac 26. With the aid of the varistor 22 a short-lived and sudden overvoltage across the diode bridge circuit 5, 11, 14 can be captured in nanoseconds. Voltage overloads of the order of milliseconds can be captured by the triac 26, which starts to operate if peaks of positive and negative alternating voltage periods exceed the Zener voltage of the Zener diodes. In that case, the triac short-circuits the overvoltage peak. It must be understood that other designs are possible for a protection circuit in which alternatives known to persons skilled in the art for the abovementioned elements can be incorporated.

Because of the use of a LED, its temperature will vary. When a temperature change occurs the intensity of the light emitted can change as well. Because, certainly if a combination of LEDs is used in order to generate a specific colour, it is desirable that the colour to be emitted remains constant, a colour correction circuit is advisable. FIGS. 8a, 8b schematically show two possible colour correction circuits. In the colour correction circuit in FIG. 8a, in addition to a variable resistor 32, for example a potentiometer 17 as shown in FIG. 6c, a transistor 31 in combination with a temperature-sensitive resistor, for example an NTC (negative temperature coefficient) resistor 30, is used. Such an NTC resistor 30 is in particular very suitable when a substrate made of ceramic is used. In the case where a diode bridge circuit is used that emits white light as mixed colour, it is possible to vary the mixed colour along a curve that virtually follows the so-called Planck curve with the variable resistor 32 from “cold” white (8000 K) to “warm” white (2000 K). By suitable dimensioning of the various components 30, 31, 32 the circuit can be set such that a change in temperature brings about a change in the NTC resistor 30, which compensates for the temperature change, as a result of which the spectrum of wavelengths emitted does not substantially change over time.

In the colour correction circuit in FIG. 8b the role of the NTC resistor 30 is taken over by a phototransistor 33, for example a so-called Darlington transistor chip. Such a photo-transistor 33 is preferably incorporated close to one of the tight-emitting LEDs on the substrate. As a consequence of the change in the intensity of the light emitted as a result of temperature change, the conduction of the transistor 31 changes as a consequence of another base voltage on the transistor 33. By a suitable selection of components 31, 33, this change in resistance can compensate the change in the colour mix ratio as a consequence of the temperature change, as a result of which the spectrum of wavelengths emitted does not change substantially over time. In this respect it must be understood that, although this is possibly not explicitly apparent from FIG. 8b, light originating from one of the LEDs 6, 7, 8, or 9 can fall on the phototransistor 33. Furthermore, in order to set a desired colour, it is possible to incorporate a variable resistor 32 in this circuit as well.

The compensation in FIG. 8a is entirely based on thermal compensation. The compensation in FIG. 8b is based on optical compensation. Both compensation methods can obviously be combined.

FIG. 9 schematically shows a circuit according to a sixth embodiment of the present invention. In contrast to the previous circuits, the bridge does not contain single elements per current path but diode bridge circuits 40, 41, 42, 43 according to the present invention, in this case diode bridge circuits such as shown in FIG. 3b. The great advantage of connecting these diode bridge circuits 40, 41, 42, 43 in the form of a bridge is the fact that when one of the light-producing elements, for example LEDs 12, 13 fails, the bridge in which that occurs can continue to radiate light. The other bridges in the bridge circuit of diode bridge circuits continue to function fully. Consequently, the so-called mean time to failure (MTTF) of the reactive circuit is extended. Even if a diode bridge circuit in the bridge circuit were to comprise a circuit such as shown in FIG. 3a, it is possible on failure of one LED 10 for sufficient light still to be generated to keep using the lighting device. Just as with the circuits shown earlier, it is possible for one or more of the other diodes in the bridge to be LEDs as well. At the same time it is also possible to incorporate a number of diodes and/or LEDs connected in series or parallel in the circuit instead of one diode.

It is also possible with bridged diode bridge circuits to generate light with different wavelengths, that is to say of different colours. In contrast to the non-bridged diode bridge circuits, all LEDs in a single diode bridge circuit can emit tight with the same wavelength. By now choosing LEDs that produce another colour for each diode bridge circuit, once again a wide variety of mixed colours can be generated. It is thus possible to have the bridged diode bridge circuit as a whole generate white light by a suitable combination of “green”, “red” and “blue” bridges.

FIG. 10 schematically shows a side view of a circuit according to an embodiment of the present invention, for example a circuit such as shown in FIGS. 3a, 3b and 4, wherein a heat-conducting surface 51 has been applied to one side of the substrate 50. An electrically conducting surface 52 has been applied to the other side of the substrate, which surface has been organised for permanent joining to a connection side of the rectifier circuit, for example for joining to diodes 6 and 7 in the circuit in FIGS. 3a, 3b and 4. For good heat conduction and resistance to deformation in the case of temperature differences, the conducting layers 51, 52 preferably comprise at least one of the elements from the group comprising silver (Ag), chromium (Cr), nickel (Ni) and copper (Cu). The join can be made by soldering, for example with a solder that comprises gold (Au) and tin (Sn). In FIG. 6, p-regions and n-regions of diodes 6 and 7 are represented as blank rectangles and rectangles with cross-hatching, respectively. Links that are not directly connected to the electrically conducting layer 52 are formed by connecting wires, also called “bonding wires”, such as connecting wires 53.

The above description sets out only a number of possible embodiments of the present invention. It is easy to appreciate that many alternative embodiments of the invention can be conceived, all of which fall within the scope of the invention. This is defined by the following claims.

1. Reactive circuit for correction of a power factor in an electrical network comprising
at least one supply connection for supplying an alternating power supply current;
an input stage that is connected to the at least one supply connection and in use generates an essentially reactive input impedance and a correction current for correction of the power factor;
one or more LEDs;
characterised in that the reactive circuit is set up for lighting a space by loading one or more LEDs with the at least nearly full correction current.

2. Reactive circuit according to claim 1, characterised in that the correction current has an electrical current intensity of at least 200 mA.

3. Reactive circuit according to claim 1 or 2, characterised m that the input stage comprises at least one capacitor (2) connected in series between the at least one supply connection and the one or more LEDs.

4. Reactive circuit according to claim 3, characterised in that the circuit is placed on a substrate (20), wherein a first heat-conducting surface (21) has been applied to a first side of the substrate and an electrically conducting surface (22) has been applied to a second side of the substrate, which electrically conducting surface is organised for permanent joining to the one or more LEDs.

5. Reactive circuit according to claim 4, characterised in that the permanent joining of the one or more LEDs to the electrically conducting surface (52) on the second side of the substrate (50) is achieved by soldering.

6. Reactive circuit according to claim 4 or 5, characterised in that the electrically conducting surface (52) comprises at least one of the elements from a group comprising silver (Ag), chromium (Cr), nickel (Ni) and copper (Cu) comprises and the substrate (50) comprises ceramic.

7. Reactive circuit according to any one of the preceding claims, characterised in that the reactive circuit contains a two-phase rectifier circuit (3, 4, 5, 11, 14) that puts one or more LEDs under load for each phase.

8. Reactive circuit according to claim 7, characterised in that the two-phase rectifier circuit comprises a diode bridge circuit (5, 11, 14), wherein the diode bridge circuit (5, 11, 14) comprises a current branch comprising diodes (6, 7, 8, 9) for each phase, wherein part of both current branches comprises a common section and the common section comprises the one or more LEDs.

9. Reactive circuit according to claim 8, characterised in that the common section of both current branches comprises at least two parallel electrically conducting paths that each comprise at least one or more LEDs.

10. Reactive circuit according to claim 8 or 9, characterised m that at least one additional capacitor (15) is connected in parallel with the common section of both current branches.

11. Reactive circuit according to any one of claims 8-10, characterised in that at least one of the diodes (6, 7, 8, 9) in the diode bridge circuit (5, 11, 14) is a LED.

12. Reactive circuit according to any one of the preceding claims, characterised in that it contains various LEDs and different LEDs can generate light of another colour.

13. Reactive circuit according to claim 12, characterised in that the reactive circuit furthermore comprises an adjusting element (17, 30, 31, 32, 33) for setting the colour to be emitted.

14. Reactive circuit according to claim 13, characterised in that the adjusting element is a variable resistor (17, 32).

15. Reactive circuit according to claim 13, characterised in that the adjusting element is incorporated in a colour correction circuit.

16. Reactive circuit according to claim 15, characterised in that the colour correction circuit comprises a transistor (31) and an NTC resistor (30), wherein the NTC resistor (30) is connected to the base of the transistor (31).

17. Reactive circuit according to claim 15, characterised in that the colour correction circuit comprises a transistor (31) and a phototransistor (33), wherein the phototransistor (33) is connected to the base of the transistor (31).

18. Reactive circuit according to claim 17, characterised in that the phototransistor (33) is a Darlington transistor.

19. Reactive circuit according to claim 18, characterised in that the reactive circuit generates virtually white light in use.

20. Reactive circuit according to claim 1, characterised in that the reactive circuit comprises a bridge circuit containing several diode bridge circuits (5, 11, 14), wherein each diode bridge circuit comprises a current branch comprising diodes (6, 7, 8, 9) for each phase, wherein part of both current branches is a common section and the common section comprises the one or more LEDs.

21. Reactive circuit according to claim 20, characterised in that the diode bridge circuits (5, 11, 14) in the bridge circuit generate light of different wavelengths in use.

22. Reactive circuit according to claim 21, characterised in that the generated wavelength per diode bridge circuit (5, 11, 14) is chosen such that the lighting device generates virtually white light in use.

23. Reactive circuit according to any one of the preceding claims, characterised in that the input stage is made up of a capacitor array that comprises one or more capacitors connected in parallel.

24. Reactive circuit according to any one of the preceding claims, characterised in that the at least one supply connection is suitable for connecting the device to an electricity network (1).

25. Reactive circuit according to any one of the preceding claims, characterised in that the reactive circuit furthermore comprises a protection circuit.

26. Rectifier circuit for electrically loading at least one LED, wherein the rectifier circuit is a two-phase rectifier circuit that comprises a diode bridge circuit (5, 11, 14), wherein the diode bridge circuit (5, 11, 14) comprises a current branch comprising diodes (6, 7, 8, 9) for each phase, characterised in that part of both current branches comprises a common section, wherein the common section comprises the at least one LED and the at least one LED is loaded to an electrical power of at least 60 mW.

27. Rectifier circuit according to claim 26, characterised in that the common section of both current branches comprises two parallel electrically conducting paths that each comprise one or more LEDs.

28. Rectifier circuit according to claim 26 or 27, characterised in that at least one capacitor (15) is connected in parallel with the common section of both current branches.

29. Rectifier circuit according to one of claims 26-28, characterised in that at least one of the diodes (6,7,8,9) in the diode bridge circuit (5,11,14) is a LED.

30. Rectifier circuit according to one of claims 26-29, characterised in that it comprises various LEDs, and different LEDs can generate light of another colour.

31. Rectifier circuit according to claim 30, characterised in that the rectifier circuit generates virtually white light in use.
